(19) United States
(12) Patent Application Publication
(10) Pub. No.: US 2006/0250787 A1
(43) Pub. Date: Nov. 9, 2006

(54) Rechargeable pointer pen with USB connector

(75) Inventors: David Ho, Taipei (TW); Yi Xing, Shanghai (CN)

Correspondence Address: BACON & THOMAS, PLLC, 625 SLATERS LANE, FOURTH FLOOR, ALEXANDRIA, VA, 22314, US

(73) Assignee: Inventec Appliances Corp., Taipei (TW)

(21) Appl. No.: 11/418,296

(22) Filed: May 5, 2006

(30) Foreign Application Priority Data
May 6, 2005 (TW) 094207332

(51) Int. Cl. F21L 4/00; F21L 13/00

(52) U.S. Cl. 362/118; 362/183

(57) ABSTRACT

A pointer pen which is disclosed includes a rechargeable battery, a switch, a light-emitting element, and an interface unit including a voltage transforming and charging circuit and a USB connecter. The USB connector may be plugged into a USB port of a device (e.g., laptop computer) when the battery run down. Thereafter, an external power is supplied to the voltage transforming and charging circuit for voltage transformation through the connection between the USB connector and the USB port. The transformed voltage is then supplied to the battery for charging. The pointer pen has a prolonged operating time and is capable for being charged quickly in a convenient way when its battery runs down while a lecture is given.

### FIELD OF THE INVENTION

The present invention relates to pointer pens and more particularly to a rechargeable pointer pen with a USB (Universal Serial Bus) connector (e.g., USB type A connector) adapted to plug into a computer (e.g., a laptop computer) for charging the pointer pen if it is discharged.

### BACKGROUND OF THE INVENTION

It is a challenge for office employees to be in this information explosion and technology advancement era since they have to catch up with the trend. In this regard, many large companies may hold seminars or lectures about latest information technologies or other important topics for educating the employees. Typically, a lecturer may use a laptop computer, a projector, a screen, and a pointer pen in his or her speech. The screen is adapted to show the speech contents projected by the projector and the pointer pen is used as a source of illumination for indicating important points of the contents shown on the screen while a lecture is given. Hopefully, the audience can understand what the lecturer is speaking.

A conventional cylindrical pointer pen 11 is shown schematically in FIG. 1 and comprises two cells 12 connected in series, a trigger switch 13, and a light-emitting element 14. Referring to FIG. 2, an operation of the pointer pen 11 is shown schematically. As shown in FIG. 2 in conjunction with FIG. 1, during using the pointer pen 11 a user (e.g., a lecturer) may press the trigger switch 13 to activate the cells 12 in the pointer pen 11. The cells 12 then supply electric current to the light-emitting element 14 which in turn is adapted to emit light 15 to illuminate a desired area on a screen for indication while a lecture is given. Referring to FIG. 3, a circuit diagram of the pointer pen 11 is shown. It is understood that electric current is continuously supplied from the cells 12 to the light-emitting element 14 as long as the cells 12 in the pointer pen 11 is being activated. It is also understood that the effective operating time of the cell 12 is limited. A sufficient light 15 cannot be emitted by the light-emitting element 14 when the cells 12 run down. In this case the lecturer has to interrupt the lecture and replace the consumed cells 12 with new ones. This may not only cause inconvenience to the lecturer but also cause an audience to have a feeling of interruption. This is not desired.

Thus, it is desirable to provide a pointer pen having a rechargeable battery and a USB connector (e.g., USB type A connector) adapted to plug into an external power source (e.g., a desktop computer or a laptop computer) for quickly charging the battery such that the pointer pen may operate a prolonged period of time in order to overcome the inadequacy of the prior art.

### SUMMARY OF THE INVENTION

It is an object of the present invention to provide a pointer pen comprising a light-emitting element, a trigger switch, a battery, a voltage transforming and charging circuit, and a USB connector. The USB connector is a Plug-and-Play device and is made up of an electrically conductive material. The USB connector is adapted to plug into an external power source for electrical connection. The battery is a rechargeable battery. A user (e.g., a lecturer) may plug the USB connector into a USB port of a laptop computer (or a desktop computer) when the battery rundown during the speech. Power is then supplied from the laptop computer to the battery for charging through the connection between the USB connector and the USB port. Advantageously, the charging time is about two to three minutes. Thereafter, the lecturer may continue to use the pointer pen. By utilizing this pointer pen having a USB connector and a rechargeable battery, it is possible to solve the problem of frequent battery replacement as experienced by the prior art.

The above and other objects, features and advantages of the present invention will become apparent from the following detailed description taken with the accompanying drawings.

### BRIEF DESCRIPTION OF THE DRAWINGS

FIG. 1 is a schematic view of a conventional pointer pen;

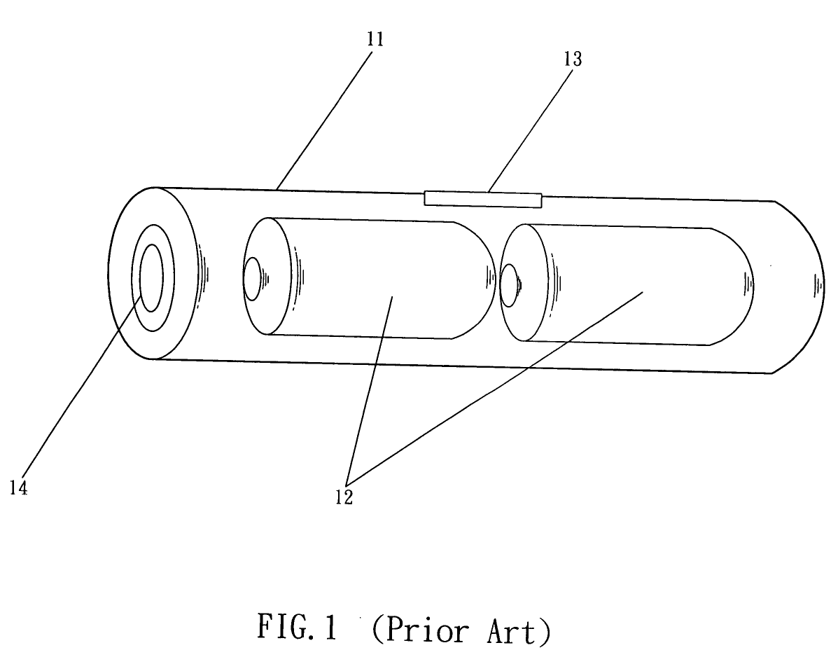

FIG. 2 is a schematic view similar to FIG. 1 showing an operation of the pointer pen;

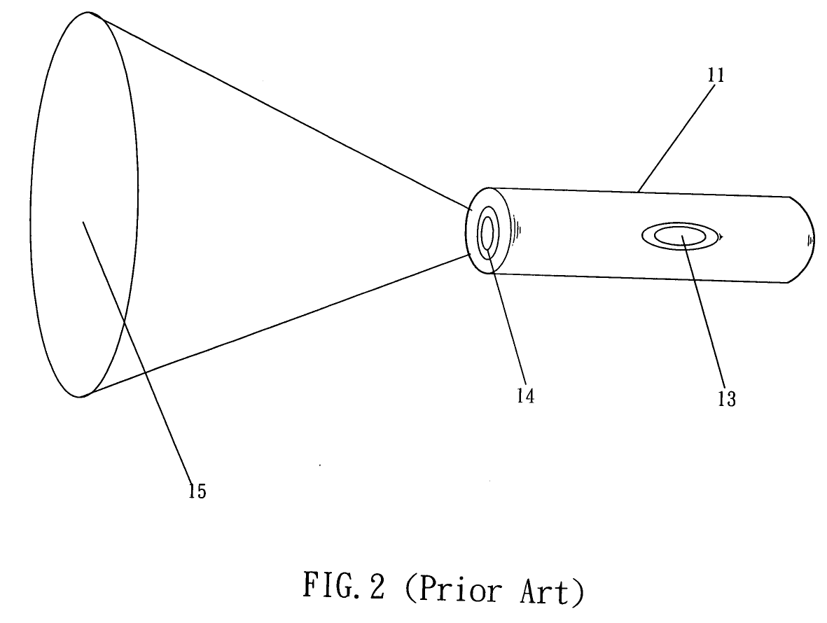

FIG. 3 is a circuit diagram of the pointer pen;

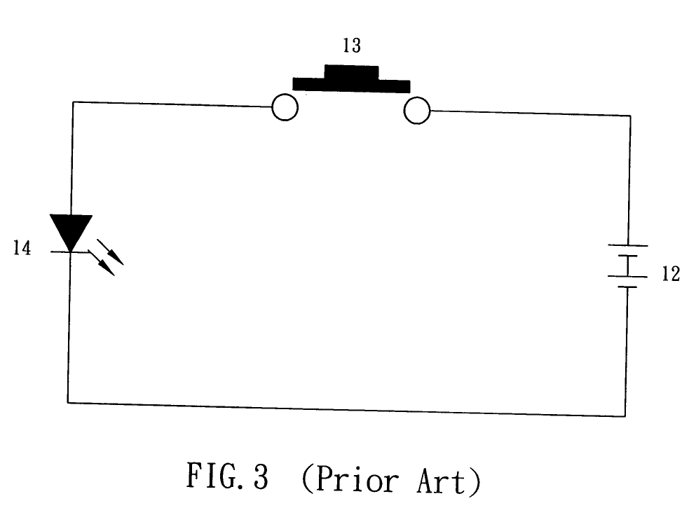

FIG. 4 is a schematic view of a preferred embodiment of the pointer pen according to the present invention;

FIG. 5 is a circuit diagram of the pointer pen shown in FIG. 4; and

FIG. 6 is an environmental view of the pointer pen about connecting to a laptop computer for charging.

### DETAILED DESCRIPTION OF THE PREFERRED EMBODIMENTS

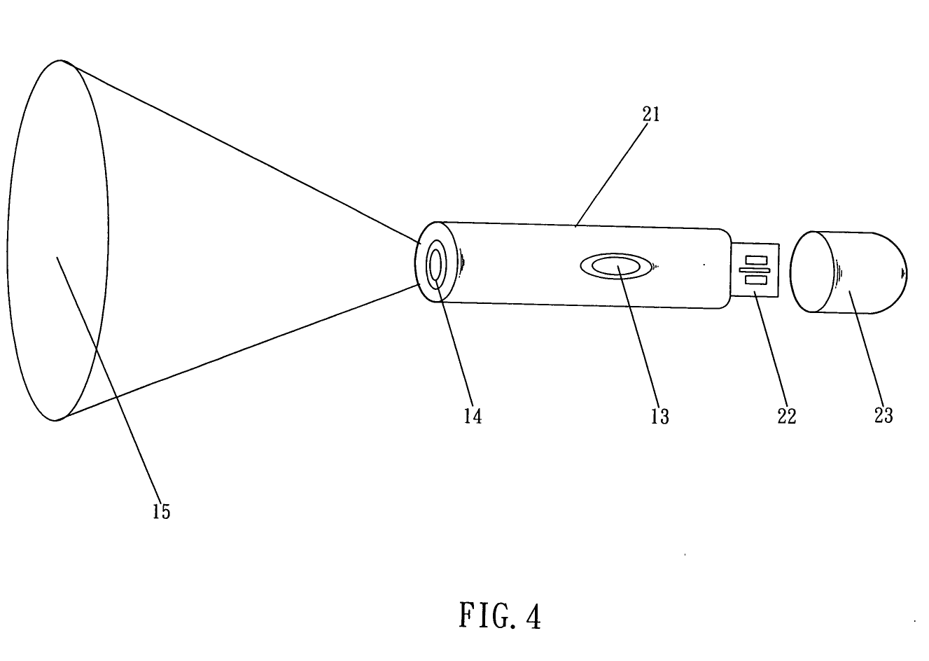

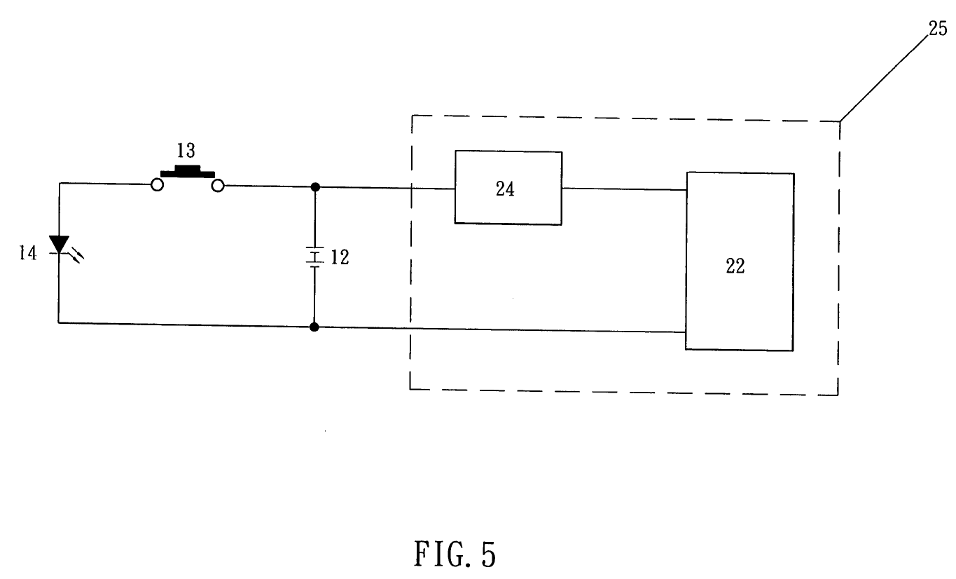

Refer to FIG. 4 and FIG. 5, a pointer pen 21 in accordance with a preferred embodiment of the invention is shown. The cylindrical pointer pen 21 comprises an internal battery 12, a trigger switch 13 on its outer surface, a front light-emitting element 14 made up of a semiconductor material, and an interface unit 25. The interface unit 25 comprises a voltage transforming and charging circuit 24 electrically connected to the battery 12, and a USB connector (e.g., USB type A connector) 22 electrically interconnected to the voltage transforming and charging circuit 24 and the battery 12. The battery 12 is a rechargeable battery. In use, a user (e.g., a lecturer) may press the trigger switch 13 to activate the battery 12. The battery 12 may then supply electric current to the light-emitting element 14 which in turn is used for emitting light to illuminate a desired area on a screen for indication while a lecture is given as detailed later.

Refer to FIG. 4 again, it schematically depicts the pointer pen 21. The pointer pen 21 further comprises a rear cap 23 which is adapted to detach from the pointer pen 21 to expose the USB connector 22. A lecturer may plug the USB connector 22 into a USB port of a device (e.g., laptop computer) when the battery 12 run down. Thereafter, an external power is supplied from the laptop computer to the voltage transforming and charging circuit 24 for voltage transformation through the connection between the USB connector 22 and the USB port. The transformed voltage is then supplied from the voltage transforming and charging circuit 24 to the battery 12 for charging. The charging time is about two to three minutes. Thereafter, the lecturer may unplug the USB connector 22. Then, the lecturer may press the trigger switch 13 to cause the battery 12 to supply electric current to the light-emitting element 14. And in turn, the light-emitting element 14 emits light 15 to illuminate a desired area on a screen for indication for continuing the lecture.

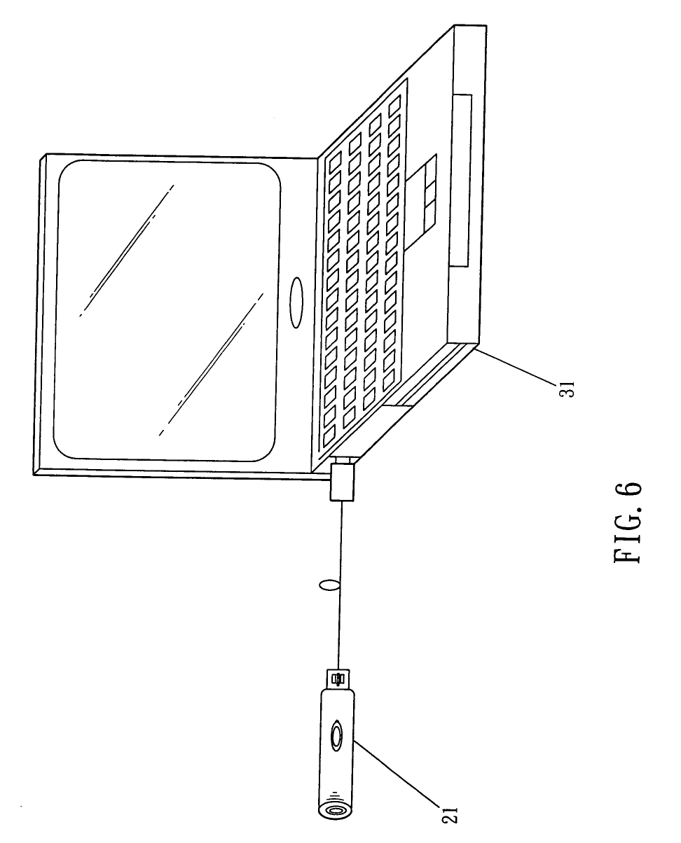

Refer to FIG. 6 in conjunction with FIG. 4, a charging operation of the pointer pen 21 of the invention is shown. For charging the consumed battery 12 in the pointer pen 21, a user (e.g., a lecturer) may plug the USB connector 22 into a USB port of a laptop computer 31. The USB connector is a Plug-and-Play device and is made up of an electrically conductive material. Also, a USB port is standard piece of equipment for a desktop computer or laptop computer. Thus, a rechargeable pointer pen with a USB connector as contemplated by the invention can satisfy a battery charging need while a lecture is given by a lecturer who uses the pointer pen as a source for illuminating important points of the lecture contents being given.

While the invention herein disclosed has been described by means of specific embodiments, numerous modifications and variations could be made thereto by those skilled in the art without departing from the scope and spirit of the invention set forth in the claims.

What is claimed is:

1. A pointer pen comprising:
a light-emitting element for functioning as a light source by emitting light;
a battery for supplying electricity to the light-emitting element; and
an interface unit for electrically connecting to the battery and an external power source, the external power source being for charging the battery.

2. The pointer pen of claim 1, further comprising a switch for connecting or disconnecting electricity supplied by the battery to the light-emitting element.

3. The pointer pen of claim 2, wherein the switch is a trigger switch.

4. The pointer pen of claim 1, wherein the light-emitting element emits directionally-pointing light.

5. The pointer pen of claim 1, wherein the light-emitting element comprises a semiconductor material.

6. The pointer pen of claim 1, wherein the battery is a rechargeable battery.

7. The pointer pen of claim 1, wherein the interface unit comprises a circuit.

8. The pointer pen of claim 7, wherein the circuit comprises a voltage transforming circuit.

9. The pointer pen of claim 7, wherein the circuit comprises a charging circuit.

10. The pointer pen of claim 7, wherein the interface unit further comprises a USB (Universal Serial Bus) connector electrically connecting to the external power source for charging the battery.

11. The pointer pen of claim 10, wherein the USB connector is made up of an electrically conductive material.

12. The pointer pen of claim 10, wherein the USB connector is a Plug-and-Play device.
